(19) United States
(12) Patent Application Publication
(10) Pub. No.: US 2023/0196601 A1
(43) Pub. Date: Jun. 22, 2023

(54) APPARATUSES AND METHODS FOR DETERMINING THE VOLUME OF A STOCKPILE

(71) Applicant: Purdue Research Foundation, West Lafayette, IN (US)

(72) Inventors: Ayman F. HABIB, West Lafayette (IN); Darcy M. BULLOCK, West Lafayette (IN)

(21) Appl. No.: 18/068,960

(22) Filed: Dec. 20, 2022

Related U.S. Application Data
(60) Provisional application No. 63/265,779, filed on Dec. 20, 2021.

(51) Int. Cl. G06T 7/62; G06T 7/73; G06V 10/75

(52) U.S. Cl. CPC G06T 7/62; G06T 7/74; G06V 10/751

(57) ABSTRACT

Systems and methods for determining the volume of a stockpile are disclosed. Embodiments include one or more detectors (sensors and/or cameras) and processing of the data gathered from the detectors in a manner that provides accurate volume estimates without requiring the exact location of the detectors. Some embodiments utilize one or more image cameras and LiDAR sensors to obtain data about the stockpile and compute the volume of the stockpile using one or more of the following procedures: segmentation of planar features from individual scans; image-based coarse registration of sensor scans at a single station; feature matching and fine registration of sensor point clouds from a single station; coarse registration of point clouds from different stations; feature matching and fine registration of sensor point clouds from different stations; and digital surface model generation for volume estimation. Some embodiments are connectable to extendable mounts and are very easy to operate.

This application claims the benefit of U.S. Provisional Application No. 63/265,779, filed Dec. 20, 2021, the entirety of which is hereby incorporated herein by reference.

### GOVERNMENT RIGHTS

This invention was made with government support under contract number SPR-4549 awarded by the Joint Transportation Research Program. The government has certain rights in the invention.

### FIELD

Embodiments of this disclosure relate generally to determining the amount of material in a stockpile, such as stockpiles of salt, rocks, earth/dirt, landscaping mulch, or grain. Some example embodiments include the use of an integrated sensor and camera system to determine and/or estimate large three-dimensional (3D) volumes of material in enclosed and/or outdoor environments.

### BACKGROUND

Large piles of salt are used for storing such salt for later use, such as for spreading on roads to melt roadway ice during winter weather months. These large piles of salt are frequently stored in enclosures. Estimating the size/volume of a large pile of stockpiled salt is important in commerce and infrastructure. Determining the amount of salt in a pile helps determine which locations have insufficient or excessive salt and helps entities, such as the Department of Transportation (DOT), utilize salt resources in a timely and efficient manner.

Estimations of the amount of material in a pile have traditionally been accomplished using tape measures, counting truck loads, photographic imaging and/or static laser scanning.

However, it was realized by the inventors of the current disclosure that problems exist with the existing techniques for determining and/or estimating the amount of salt in a large stockpile of salt. Example problems realized by the inventors include large amounts of human and/or computational time, dangerous and/or excessive labor requirements, expensive systems to own and/or operate, poor performance in low light environments, poor performance in locations where remote navigation systems (such as a global navigation satellite system—GNSS—one example being the Global Positioning System (GPS)) are degraded or unavailable, locations of stockpiles where safe operation of unmanned aerial vehicles is not available, locations of stockpiles where parts of the piles are inaccessible, and/or low accuracies. As such, the inventors realized that improvements in the ability to estimate and/or determine the amount of salt in a large stockpile are needed.

Certain preferred features of the present disclosure address these and other needs and provide other important advantages.

SUMMARY

Embodiments of the present disclosure provide improved apparatuses and methods for determining the volume of a stockpile.

Embodiments of the present disclosure include creation of sensor, e.g., LiDAR (light detection and ranging), point clouds derived through a sequence of data collection events from different scans and an automated image-aided sensor coarse registration technique to handle the sparse nature of the collected data at a given scan, which may be followed by a segmentation approach to derive features (such as features of adjacent structures), which can be used for fine registration. The resulting 3D point cloud can be subsequently used for accurate volume estimation.

Embodiments of the present disclosure determine the volume of a stockpile by collecting what would normally be considered to be sparse amounts of data for previous systems/methods and uses unique data analysis techniques to determine the volume of a stockpile. While current systems can produce acceptable results with larger and more expensive (both monetarily and computationally) systems (for example, current systems attached to unmanned aerial vehicles (UAVs) utilize encoders (e.g., GPS encoders) to precisely track the orientation and location of the LiDAR scanners), embodiments of the present disclosure can determine/estimate the volume of a stockpile as accurately (if not more accurately) than the more expensive systems by using the collected data (which, again, is sparse in relation to the amount of data collected by typical systems) to determine the amount of rotation and/or translation of the system actually occurred instead of relying on continually tracking the exact location and orientation of the sensors. Once the rotation and translation of the system are known, the collected data can be used to calculate the volume of the stockpile.

Further embodiments of the present disclosure include portable and stationary systems and methods that use sensors (e.g., LiDAR) that inventory a stockpile (e.g., a large stockpile of salt or grain) in a small amount of time, such as in a number of minutes (e.g., under 15 minutes). Example systems include pole mounted systems, systems mounted to the roofs of stockpile enclosures, and systems mounted to remote vehicles (e.g., unmanned aerial vehicles).

Advantages realized by embodiments of the present disclosure include a portable system/platform including smaller amounts of hardware (for example, a single camera and two light detection and ranging (LiDAR) sensors), which are typically less expensive than existing systems, that can quickly acquire indoor stockpile data with minimum occlusions, and/or a system/platform that can formulate data processing strategies to derive reliable volume estimates of stockpiles in an environment where remote navigation is impaired (referred to herein as a “GPS-denied” environment), poor lighting, and/or stockpiles with featureless surface characteristics. Additional advantages include a simpler manner for operators to operate the system since precise placement and rotational increments are not required.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 depicts a Stockpile Monitoring and Reporting Technology (SMART) system according to at least one embodiment of the present disclosure. System setup for data acquisition within an indoor facility is shown on the left.

FIG. 2 is a schematic of the horizontal coverage of light detection and ranging (LiDAR) units and RGB camera on the SMART system depicted in FIG. 1.

FIG. 3 is an integration scheme for the SMART system components.

FIG. 4 is a schematic illustration of SMART system rotation at a given station.

FIG. 5 depicts locations of surveyed salt storage facilities: US-231 unit in West Lafayette, Indiana, USA; and Lebanon unit in Lebanon, Indiana, USA.

FIG. 6 depicts workflow of the proposed stockpile volume estimation using a SMART system.

FIG. 7 is a schematic diagram illustrating the point positioning equations for 3D reconstruction using camera and LiDAR units mounted on a SMART system. For a better visualization of system parameters, the camera and LiDAR units are depicted much farther from the pole compared to their actual mounting positions.

FIG. 8 is a depiction of an example of varying orientation of planar features and significant variability in point density in one scan from the SMART system, colored by height. The TLS point cloud of the facility colored by RGB is shown in the upper left box.

FIG. 9 is an illustration of a proposed SLS strategy with points pertaining to two smooth curve segments. A set of sequentially scanned points is assumed to consist of 5 points and the outlier threshold n_{T} is set to 2.

FIGS. 10A, 10B, 10C and 10D depict sample results for an SLS approach. FIG. 10A depicts point cloud from a single beam scan. FIG. 10B depicts smooth curve segments along the same point cloud (different curve segments are in different colors). FIG. 10C depicts derived smooth curve segments from all laser beams in a LiDAR scan (different curve segments are in different colors). And, FIG. 10D depicts planar feature segmentation results (different planar features are in different colors).

FIGS. 11A and 11B are graphical depictions of coarse registration results using nominal rotation angles for two scans (k=3 and k=5) in the US-231 dataset. FIG. 11A is a top-view and FIG. 10B is a side view. The colors of the point clouds are established by scan ID.

FIG. 12 flowchart of a rotation-constrained image matching for the SMART system according to one embodiment of the present disclosure.

FIGS. 13A and 13B are illustrations of rotation-constrained image matching. FIG. 13A depicts predicted point location and matching search window size in a first iteration, and FIG. 13B depicts progression of the matching evaluation through the iterations.

FIGS. 14A and 14B depict sample matching results for a stereo-pair in an example (US-231) dataset. FIG. 14A depicts rotation-constrained matching after one iteration with 513 matches and projection residual of 230 pixels. FIG. 14B depicts rotation-constrained approach after two iterations with 2,127 matches and projection residual of 25 pixels. Only 10% of the matches are illustrated in FIGS. 14A and 14B to provide better visualization.

FIGS. 15A and 15B depict image-based coarse registration results for two scans (k=3 and k=5) of a station in an example (US-231) dataset which have been originally aligned using the nominal pole/mount rotation angle (see, FIGS. 11A and 11B). FIG. 15A is a top-view and FIG. 15B is a side view. The colors of the point clouds are established by scan ID.

FIGS. 16A and 16B depict illustrations of feature-based fine registration. FIG. 15A is a schematic diagram of a planar feature before and after adjustment, and FIG. 15B is a sample point cloud (with seven scans) before and after registration with each scan represented by a single color

FIGS. 17A and 17B depict example boundary tracing of a facility. FIG. 17A depicts boundary points extracted from projected point cloud, and FIG. 17B depicts Minimum Bounding Rectangles (MBR) extracted from boundary points.

FIG. 18 is a schematic illustration of stockpile surface generation and volume estimation according to embodiments of the present disclosure.

FIGS. 19A, 19B and 19C depict example digital surface models of a stockpile. FIG. 19A depicts a combined fine registered point cloud from all stations. FIG. 19B depicts an extracted stockpile surface. And, FIG. 19C depicts an interpolated digital surface model (DSM).

FIG. 20 illustrates a system according to embodiments of the present disclosure.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

While prior systems/methods utilize precise information (usually supplied by a satellite navigation system) about the location and orientation of sensors used to detect stockpiles, embodiments of the present disclosure utilize data processing (typically of sparse data sets) to determine the location and orientation of sensors in relation to a stockpile. For example, some embodiments utilize an image sensor (e.g., a camera) that is rotated a nominal amount to gather image data at a number of rotational orientations, then use the image data to determine an estimate of the amount the image sensor has been rotated for each image, which can determine the amount of rotation to within ±1-2 degrees. To accomplish this, an initial order of magnitude for incremental camera rotation (e.g., 30 degrees, which the operator tries to generally match while rotating a camera, e.g., on a pole, but cannot match exactly) through a sufficient amount to capture the entire stockpile, which may be as much as 360 degrees) can be used to computationally estimate (e.g., using a closed-form solution that may be generated using quaternions and image matching) the amount of each rotation. In these initial computations it can be assumed that the camera lens is on the axis of rotation. Similar techniques may also be used to estimate the translation of the system camera after the system camera has been moved to different locations. The system may then use the imaging to restrict the search space to the necessary portions instead of using an exhaustive analysis of the entire search space.

After utilizing the information gathered from the imaging device, some embodiments utilize a different/second type of sensor (such as LiDAR), which may be more precise at detecting the surface of the stockpile, to improve the estimates of rotation and translation of the system. The initial estimates using the imaging system can be used to limit the amount of data gathered and/or manipulated from the scanning system. The data from the second sensor can then be used to more precisely determine the translations and rotations of the system, which can include computationally removing the initial assumptions (such as the first and/or second sensors being located on the axis of rotation since, in reality, each sensor is located a distance from the axis of rotation) and calculate the volume of the stockpile. One manner of visualizing this step is that imaginary strings produced by the second sensor (e.g., LiDAR) are used to determine the exact translations and rotations of the system.

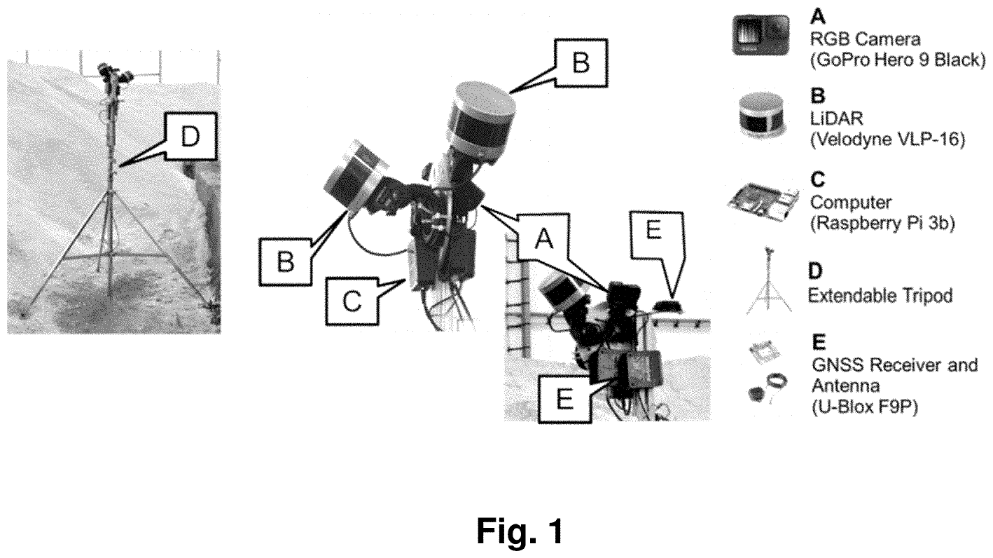

Depicted in FIG. 1 is a system for determining the volume in a stockpile according to one embodiment of the present disclosure. Embodiments of systems for determining the volume in a stockpile may also be referred to herein as a Stockpile Monitoring and Reporting Technology (“SMART”) systems. The system illustrated in FIG. 1 includes one or more of the following: one or more sensors (e.g., one or more LiDAR units, such as one or more Velodyne VLP16® LiDAR sensors), one or more cameras (e.g., one or more RGB cameras such as GoPro Hero 9® RGB cameras), at least one computer module, a system body, a global navigation satellite system (GNSS, e.g., a global positioning system (GPS)) receiver and antenna, and/or a power unit (e.g., a battery). At least one example embodiment includes two LiDAR units, which can have different coverage areas and provide increased point density, redundancy, increased speed, and enhanced occlusion reduction.

Embodiments of the system (e.g., type, number, and orientation of the sensors) are configured and adapted to effectively capture indoor facilities. Some embodiments utilize a single sensor (e.g., a light detection and ranging (LiDAR) unit) to produce data for stockpile volume estimation. However, additional embodiments of the SMART system use two sensors (e.g., two LiDAR units) to more quickly capture data (e.g., in four simultaneous directions when using two LiDAR units) reducing the number of scans required. Features other than the stockpile itself (e.g., walls, roof, ground, etc.) captured by the sensors are used in some embodiments as a basis to align captured point cloud data with high precision. A camera (e.g., an RGB camera) is included in some embodiments and serves as a tool for the initial (coarse) alignment of the acquired sensor data. Additionally, the camera can provide a visual record of the stockpile in the storage facility. The sensors utilized in embodiments of the disclosure produce well-aligned point clouds with reasonable density, which produces results at least as good as more expensive terrestrial laser scanner (TLS) systems.

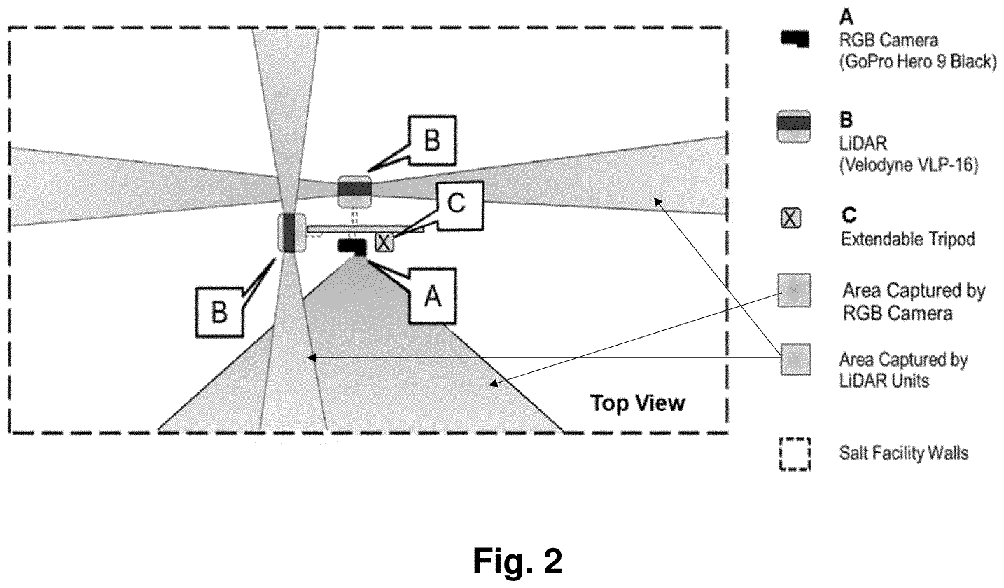

Sensor(s): In order to derive a 3D point cloud of a stockpile sensor data is acquired, such as through one or more LiDAR sensors according to at least one example embodiment of a SMART system. For example, the Velodyne VLP-16® 3D LiDAR has a vertical field of view (FOV) of 30° and a 360° horizontal FOV. Such FOV is facilitated by the unit construction, which consists of 16 radially oriented laser rangefinders that are aligned vertically from −15° to +15°, and designed for 360° internal rotation. The sensor weight is 0.83 kg and the point capture rate in a single return mode is 300,000 points per second. The range accuracy is ±3 cm with a maximum measurement range of 100 m. One advantage of using LiDAR sensors is the ability to use these sensors in a low light environment. Given the sensor specifications, two LiDAR units with cross orientation are used in some embodiments to increase the area covered by the SMART system in each instance of data collection. The horizontal coverage of the SMART LiDAR units is schematically illustrated in FIG. 2. As shown in the illustrated example embodiment, two orthogonally installed LiDAR sensors simultaneously scan the environment in a total of four directions. The 360° horizontal FOV of the VLP-16® sensors implies that the entire salt facility within the system's vertical coverage is captured by the LiDAR units. In addition to the possibility of covering larger area of stockpile, such design allows for scanning surrounding structures, thereby increasing the likelihood of acquiring diverse features in all directions from a given scan. The features of the surrounding structures (linear, planar, or cylindrical) can be used for the alignment of LiDAR data collected from multiple scans to derive point clouds in a single reference frame.

Camera(s): At least one embodiment of the SMART system uses a camera (e.g., an RGB camera, such as a GoPro Hero 9® camera, which weighs 158 g). The example camera has a 5184×3888 CMOS array with a 1.4 pm pixel size and a lens with a nominal focal length of 3 mm. Horizontal FOV of 118° and 69° vertical FOV enable the camera to cover a relatively large area in each image acquisition. In order to facilitate use in low light environments, cameras with an ability to obtain images in low light environments may be chosen. A schematic diagram of the camera coverage from an example embodiment the SMART system using such a camera is depicted in FIG. 2. In addition to providing RGB information from the stockpile, images captured by the RGB camera can be used to assist the initial alignment process of the LiDAR point clouds collected at a given station as discussed below.

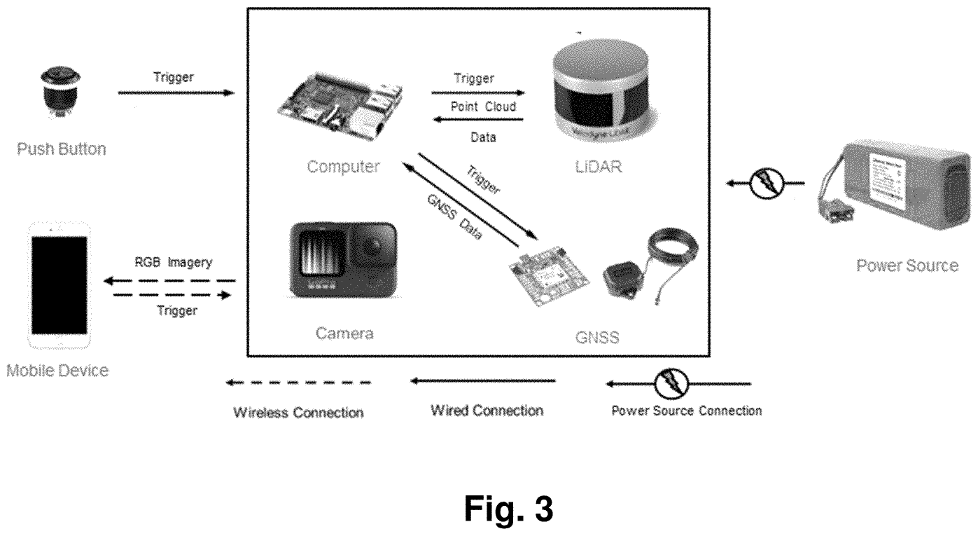

Computer Module: At least one example embodiment of a SMART system includes a computer (e.g., a Raspberry Pi ^{3b}® computer) is installed on the system body and is used for LiDAR data acquisition and storage. Both LiDAR sensors can be triggered simultaneously through a physical button that has wired-connection to the computer module. Once the button is pushed, the computer can initiate a 10-second data capture from the two LiDAR units. The example RGB camera can be controlled separately, such as by being controlled wirelessly through a mobile device. The captured images are transferred to the computer, such as through a wireless network. FIG. 3 shows the block diagram of an example system indicating triggering signals and communication wires/ports between the onboard sensors and the computer module.

Global Navigation Satellite System (GNSS) receiver and antenna: Some embodiments utilize an optional GNSS receiver and antenna to enhance SMART system capabilities. The GNSS unit can provide location information when operating in outdoor environments. The location information can serve as an additional input to aid the point cloud alignment from multiple positions of the system. Some embodiments do not include a GNSS receiver and antenna to reduce system complexity and/or costs when the system is intended for use in environments where GNSS positioning capabilities are degraded or not reliably available.

System Body: In embodiments of the present disclosure, LiDAR sensors, RGB camera, and GNSS unit of a SMART system are placed on a metal plate attached to an extendable tripod pole/mount that are together considered as the system body. The computer module and a power source can be located on the tripod pole/mount. The extendable tripod, which in some embodiments is capable of achieving a height of 6 meters or greater, helps the system in minimizing occlusions when collecting data from large salt storage facilities and/or stockpiles with complex shapes.

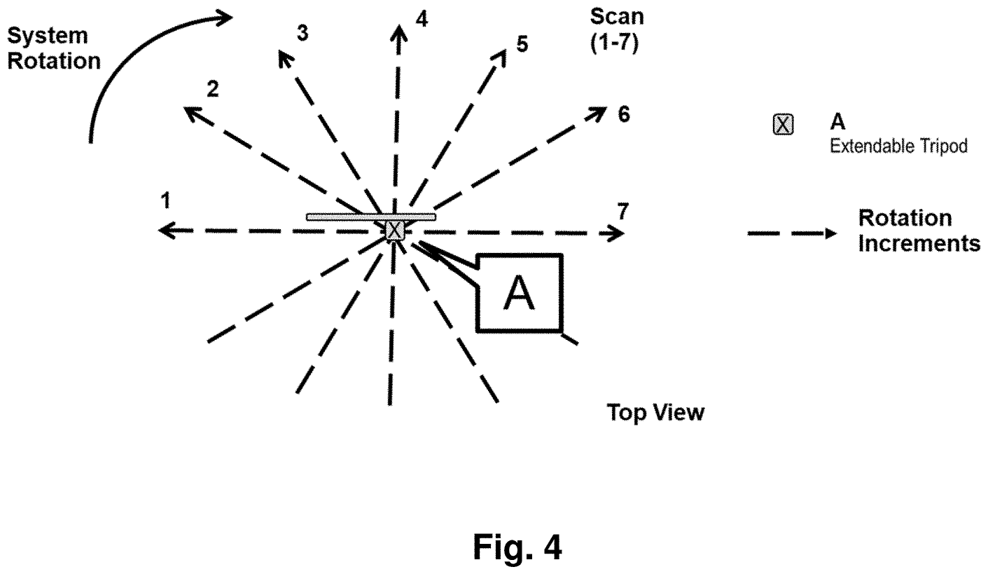

System Operation and Data Collection: At each instance of data collection, hereafter referred to as a “scan,” the SMART system can capture a pair of LiDAR scans along with one RGB image. With a 30° coverage and orthogonal mounting of LiDAR units in at least one example embodiment, the scan can extend to all four sides of a facility. On the other hand, the RGB image may be limited to providing, e.g., only 118° coverage of the site. In order to obtain a complete coverage of the facility, multiple scans from each data collection station/location may be required. To do so, the system may be rotated (e.g., manually or by use of a motor) six times around its vertical axis in approximately 30° increments for this example. This process is illustrated in FIG. 4. Thus, at a given station, seven LiDAR scans can be captured in this example. To help ensure that an adequate amount of information is obtained, the LiDAR data can be captured for 10 seconds in each scan. Some embodiments of the SMART system can have a blind spot, e.g., the area under the system, that none of the LiDAR units can capture even after being rotated, for example, by 180° . The blind spot problem is common for all tripod-based terrestrial sensors. In many cases, not all stockpile areas can be captured from one station. To solve this issue, data collection can be conducted from multiple locations (also referred to as “stations”). The number of stations varies depending on the shape and size of the stockpile/facility. Having multiple stations can eliminate the issues with blind spots under the system.

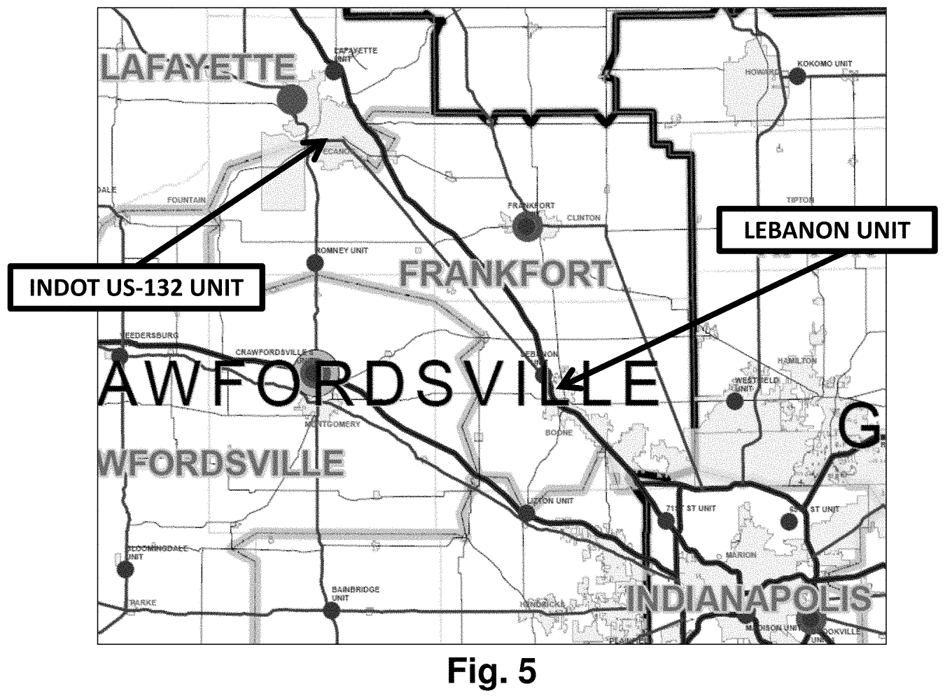

Dataset: In at least one test of an embodiment of the system, two indoor salt storage facilities with stockpiles of varying size and shape were scanned to illustrate the performance of the developed point cloud registration and volume estimation approaches. FIG. 5 shows the location of these facilities. For the purpose of identification, the two datasets are denoted as US-231 and Lebanon units located at West Lafayette and Lebanon, respectively, in Indiana, USA. Finally, to serve as a benchmark for performance evaluation, these storage facilities were also scanned using a terrestrial laser scanner (TLS) FARO Focus with range accuracy of ±2 mm. Table 1 summarizes the acquired data in the two facilities for this study.

TABLE 1
Summary of the captured salt storage facilities.

| | | | | Faro Focus | |
|---|---|---|---|---|---|
| | | SMART | | (TLS) | |
| Date | Salt | Number | Number of | Number | |
| of data | storage | of | scans per | of | |
| collection | facility | stations | station | stations | Size (W × L × H) |
| 2021 | US-231 | 1 | 7 | 3 | 30.5 m × 25.5 m × |
| Jul. 22 | unit | | | | 10 m |
| 2021 | Lebanon | 2 | 7 | 2 | 26 m × 48 m × |
| Oct. 12 | unit | | | | 10.5 m |

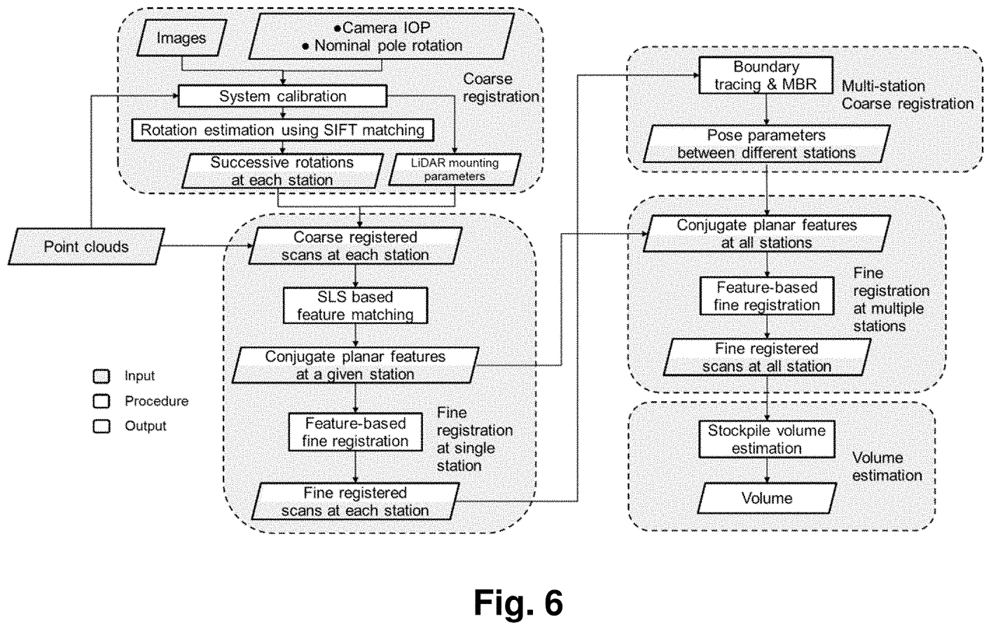

Data Processing Workflow: A first step for data processing and stockpile volume estimation can involve system calibration to estimate the internal characteristics of the individual sensors as well as the mounting parameters (i.e., lever arm and boresight angles) relating the different sensors. FIG. 6 illustrates the workflow of the proposed processing strategy, which can include one or more of the following: 1) an image-based coarse registration of captured scans at a given station; 2) feature extraction and fine registration of scans at individual stations; 3) coarse and fine registration of scans from multiple stations; and 4) volume estimation. The image-based coarse registration can be introduced to handle challenges from having sparse scans that do not have sufficient overlap. A new segmentation strategy, Scan-Line-based Segmentation (SLS), can be introduced to identify planar features, which can be used for the fine registration process. Similar to the image-based coarse registration, SLS can be introduced to mitigate point cloud sparsity and lack of sufficient overlap among the scans. The proposed strategies for coarse and fine registration together with stockpile volume estimation are presented in the following subsections.

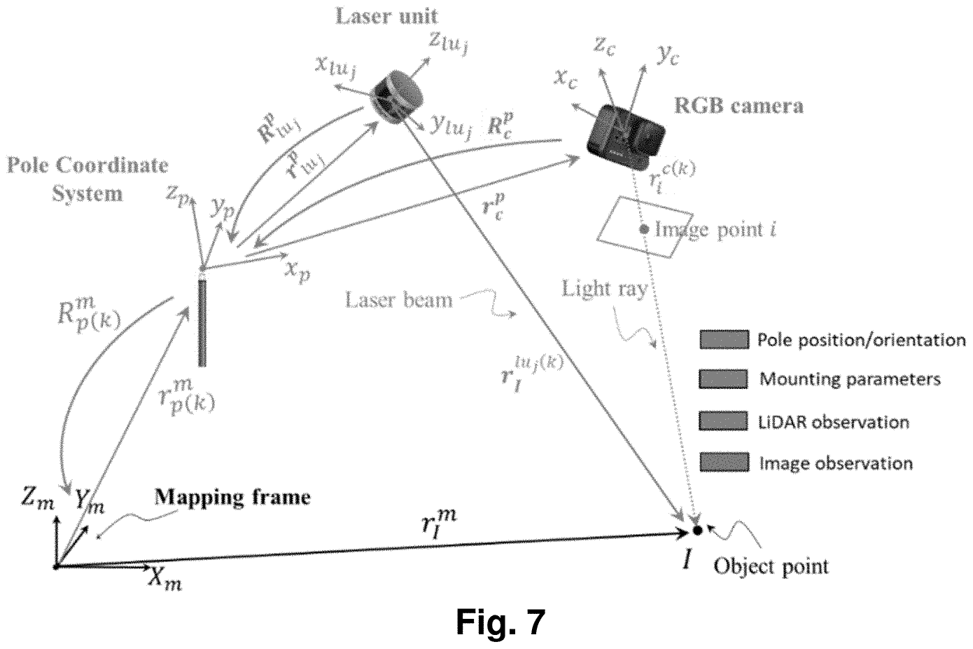

System Calibration: Embodiments utilizing SMART system calibration can determine the internal characteristics of the camera and sensor units together with the system mounting relating them to the coordinate system of the pole/mount and/or the structure of the building covering the stockpile. In some embodiments the system calibration is based on the mathematical models for image/LiDAR-based 3D reconstruction as represented by Equations (1) and (2). A schematic diagram of the image/LiDAR point positioning equations is illustrated in FIG. 7. In these equations, rᵢ^{c(k)} represents a vector from the camera perspective center c(k) to image point i in the camera frame captured at scan k. This vector is defined as [xᵢ-xₚ-distₓ_{ᵢ} yᵢ-yₚdist_{y}_{ᵢ}-c]^{T} and is derived using the image coordinates of point i and the camera's principal point coordinates (xₚ and yᵣ), principal distance (c), and distortions in the xy directions for image point i (distₓ_{ᵢ} and dist_{y}_{ᵢ}). The scale factor for image point i captured by camera c at scan k is denoted as λ(i, c, k). The position of the object point I with respect to the laser unit frame is represented by r_{I}^{lu}^{ⱼ}^{(k)} and is derived from the raw measurement of LiDAR unit j (j can be either 1 or 2 for the SMART system) captured at scan k. The position and orientation of the pole/mount frame coordinate system relative to the mapping frame at scan k are denoted as rₚ₍ₖ₎^{m} and Rₚ₍ₖ₎^{m}. The mounting parameters are defined as follows: r_{c}^{p} and R_{c}^{p} represent the lever-arm and boresight rotation matrix relating the camera system and pole/mount body frame; rₗᵤ_{ⱼ}^{p} and Rₗᵤ_{ⱼ}^{p} denote the lever-arm and boresight rotation matrix relating the laser unit j coordinate system and the pole/mount body frame. Finally, r_{I}^{m} is the coordinate of object point I in the mapping frame.

r_{I}^{m}=rₚ₍ₖ₎^{m}+Rₚ₍ₖ₎^{m}r_{c}^{p}+λ(i, c, k)Rₚ₍ₖ₎^{m}R_{c}^{p}rᵢ^{c(k)} Equation (1)

r_{I}^{m}=rₚ₍ₖ₎^{m}+Rₚ₍ₖ₎^{m}rₗᵤ^{p}+Rₚ₍ₖ₎^{p}+Rₚ₍ₖ₎^{m}Rₗᵤ_{ⱼ}^{p}r_{I}^{lu}^{ⱼ}^{(k)} Equation (2)

The internal characteristics parameters (IOP) of the sensor(s) and/or camera(s) may be provided by the manufacturer. If the internal characteristics are not provided by the manufacturer, an estimate of the internal characteristics can be made. For example, to estimate the internal characteristics of an RGB camera (camera 10P), an indoor calibration procedure can be adopted. The mounting parameters relating each sensor and the sensor mount (e.g., a pole and/or stockpile covering building) coordinate system can be derived through a system calibration procedure where these parameters are derived through an optimization procedure that minimizes discrepancies among conjugate object features (points, linear, planar, and cylindrical) extracted from different LiDAR scans and overlapping images. Since the availability of information that defines the sensor mount coordinate system relative to the mapping frame (e.g., using a GNSS unit within an indoor environment) cannot always be assumed, the system calibration may not be able to simultaneously derive the mounting parameters for, e.g., the camera and the two LiDAR units. Therefore, in at least one embodiment the mounting parameters for the first sensor unit relative to the pole/mount may not be not solved, i.e., they may be manually established and treated as a constant within the system calibration procedure. To estimate the system calibration parameters, conjugate sensor/LiDAR planar features from two sensor units and corresponding image points in overlapping images can be manually extracted. Then, the mounting parameters can be estimated by simultaneously minimizing: a) discrepancies among conjugate sensor/LiDAR features, b) back-projection errors of conjugate image points, and c) normal distance from image-based object points to their corresponding LiDAR planar features.

Once the mounting parameters are estimated, acquired point clouds from, e.g., the two LiDAR units for a given scan can be reconstructed with respect to the pole/mount coordinate system. Similarly, the camera position and orientation parameters at the time of exposure (EOP) can also be derived in the same reference frame. As long as the sensors are rigidly mounted relative to each other and the system mount (e.g., pole/mount or stockpile cover building), the calibration process may not need to be repeated.

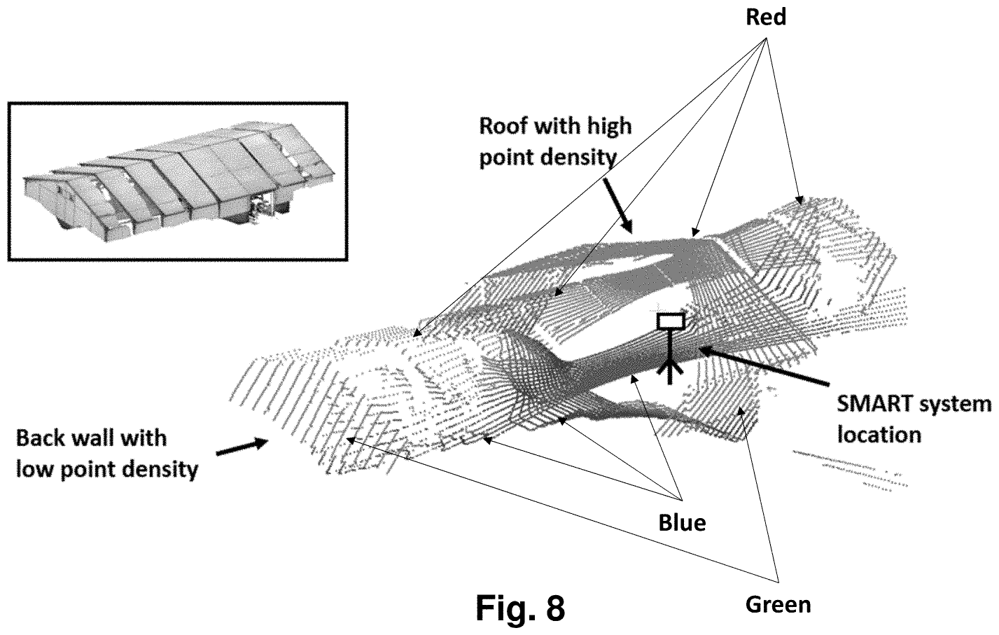

Scan-Line-based Segmentation (SLS): Having established the LiDAR mounting parameters, planar feature extraction and point cloud coarse registration can be concurrently performed. Planar features from each scan can be extracted through a point cloud segmentation process, which can take into consideration one or more of the following assumptions/traits of sensor/LiDAR scans collected by the SMART system:
a) LiDAR scans are acquired inside facilities bounded by planar surfaces that are sufficiently distributed in different orientations/locations—e.g., floor, walls, and ceiling;
b) Scans are acquired by spinning multi-beam LiDAR unit(s)—i.e., VLP-16; and
c) A point cloud exhibits significant variability in point density, as shown in FIG. 8.

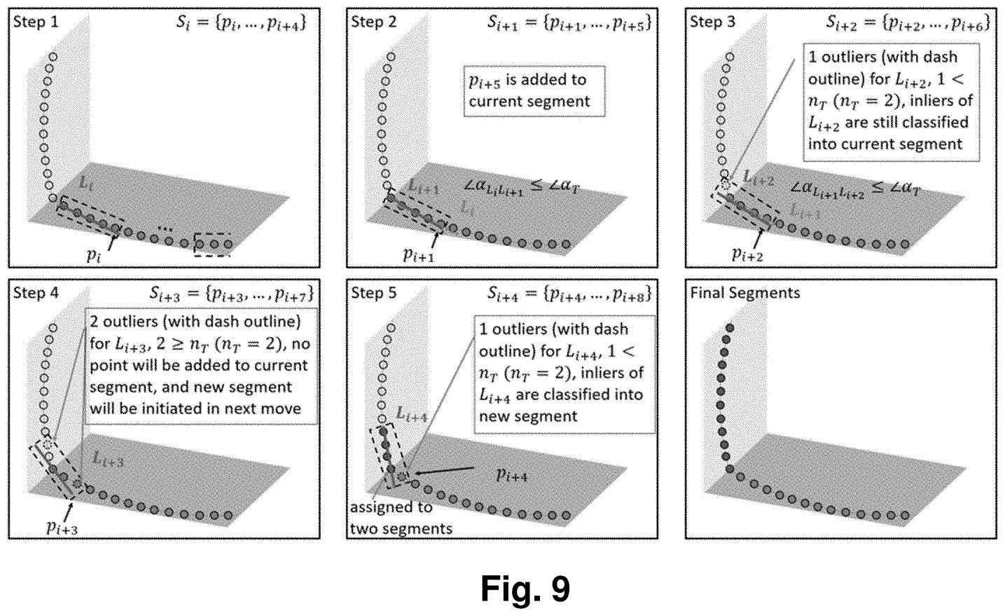

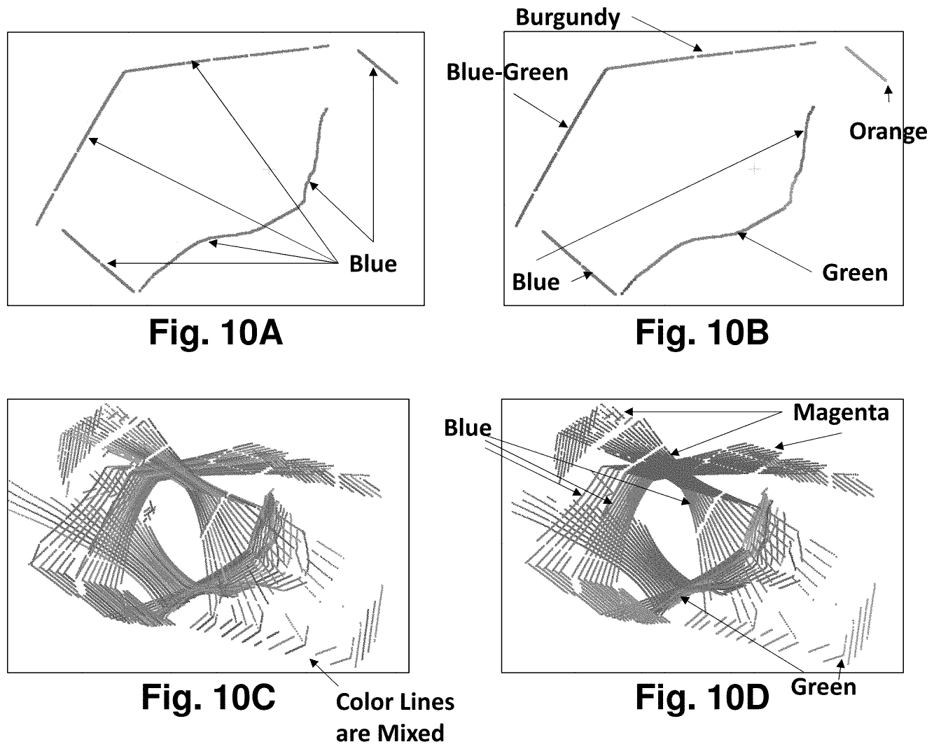

When using SLS, the locus of a scan from a single beam can trace a smooth curve as long as the beam is scanning successive points belonging to a smooth surface (such as planar walls, floor, roofs). Therefore, the developed strategy starts by identifying smooth curve segments (e.g., for each laser beam scan). Combinations of these smooth curve segments can be used to identify planar features. In at least one embodiment a smooth curve segment is assumed to be comprised of a sequence of small line segments that exhibit minor changes in orientation between neighboring line segments. To identify these smooth curve segments, starting from a given point pᵢ along a laser beam scan, two consecutive sets of sequentially scanned points, i.e., Sᵢ={pᵢ, . . . , pᵢ₊ₙ₋₁} and {Sᵢ₊₁, . . . , pᵢ₊ₙ}, are first inspected. The criteria for identifying whether a given set Sᵢ₊₁ is part of a smooth curve segment defined by Sᵢ can include: 1) the majority of points within the set Sᵢ₊₁ being modeled by a 3D line derived through an iterative least-squares adjustment with an outlier removal process (i.e., the number of outliers should be smaller than a threshold n_{T}); and/or 2) the orientation of the established linear feature is not significantly different from that defined by the previous set Sᵢ (i.e., the angular difference should be smaller than a threshold α_{T}). Whenever the first criterion is not met, a new smooth segment is initiated starting with the next set. On the other hand, when the second criterion is not met, a new smooth segment is initiated starting with the current set. Note that the moved set is shifted one point at a time. In addition, a point could be classified as pertaining to more than one smooth segment. To help ensure that the derived smooth curve segments are not affected by the starting point location in some embodiments, the process can terminate with a cyclic investigation of continuity with the last scanned points appended by the first n points. A detailed demonstration of the SLS approach for an example embodiment with a single laser beam is provided in FIG. 9. An example of the original point cloud for a given laser beam scan and its derived smooth curve segments are shown in FIGS. 10A (all lines are blue) and 10B (lines have various colors ranging from orange to burgundy to green to blue). For a calibrated system, the piece-wise smooth curve segmentation can be done for derived point clouds from the two LiDAR units at a given scan, wherein each laser beam from each unit is independently segmented. FIG. 10C shows the derived smooth curve segments for one scan captured by two LiDAR units.

The next step in the SLS workflow can be to group smooth curve segments that belong to planar surfaces. This can be conducted using a RANSAC-like strategy. For a point cloud (a LiDAR scan in this example) that is comprised of a total of nₛ smooth curve segments, a total of C_{b}_{ₛ}² pairings are established. Among all pairings, only the ones originating from different laser beams may be investigated. For each of these pairings, an iterative plane fitting with built-in outlier removal can be conducted. Then, all remaining smooth curve segments can be checked to evaluate whether the majority of the points belong to the plane defined by the pair of curve segments in question. This process can be repeated for all the pairs to obtain possible planar surfaces (along with their constituent smooth curve segments). The planar surface with the maximum number of points can be identified as a valid feature and its constituent curve segments can be dropped from the remaining possible planar surfaces. The process of identifying the best planar surface amongst the remaining curve segments can be repeated until no more planes can be added. One difference between the new segmentation strategy and RANSAC is that the new strategy performs an exhaustive investigation of all possible curve segment pairings to ensure that the system obtains as complete planar segments as possible. This can be critical given the sparse nature of a scan. FIG. 10D (line colors are grouped together and range from green to blue to magenta) illustrates the results of planar feature segmentation for the scan shown in FIG. 10C (line colors are interspersed with one another and range from red to yellow to green to blue).

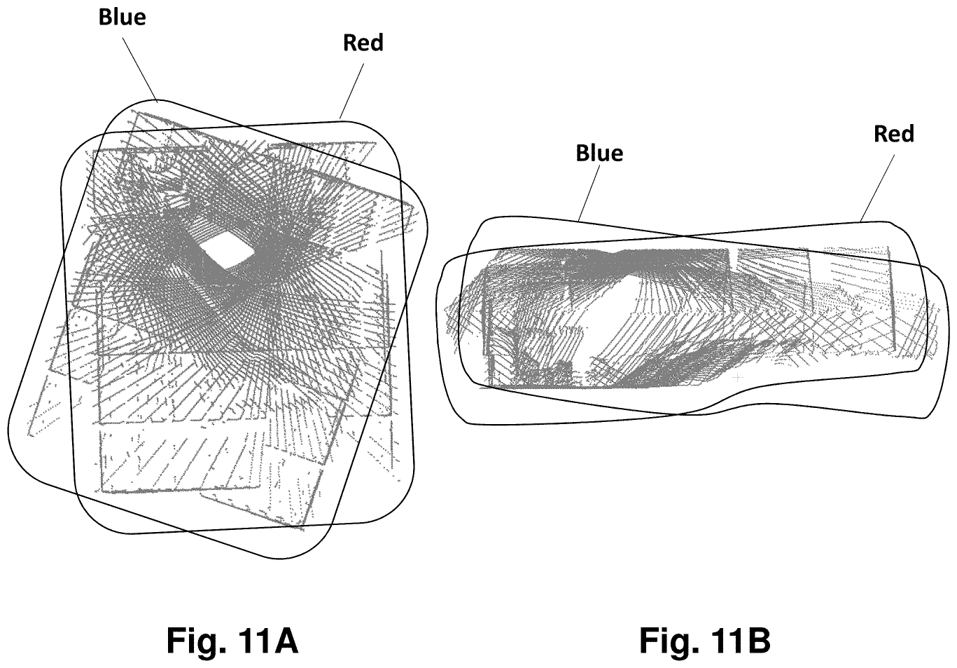

Image-based Coarse Registration: In this step, the goal is to coarsely align the sensor/LiDAR scans at each station. At the conclusion of this step, LiDAR point clouds from S scans (e.g., S=7) at a given station are reconstructed in a coordinate system defined by the pole/mount at the first scan. In other words, the pole/mount coordinate system at the first scan (k=1) is considered as the mapping frame, i.e., rₚ₍₁₎^{m} is set to [0 0 0]^{T} Wand Rₚ₍₁₎^{m} is set as an identity matrix. It may be assumed that the pole/mount does not translate between scans at a given station, i.e., rₚ₍ₖ₎^{m}=rₚ₍₁₎^{m}; but is incrementally rotated with a nominal rotation around the pole/mount Z axis (−30° in the suggested set-up). Therefore, considering the point positioning equation, Equation (2), and given the system calibration parameters rₗᵤ_{ⱼ}^{p} and Rₗᵤ_{ⱼ}^{p}, the coarse registration problem reduces to the estimation of pole rotation matrices Rₚ₍ₖ₎^{p(1)}, with k ranging from 2 to 7. The rotation matrices Rₚ₍ₖ₎^{p(1)} can be derived through the incremental pole/mount rotation estimates between successive scans; i.e., Rₚ₍ₖ₎^{p(k-1)} (2≤k≤7). One should note that although the incremental rotation matrix is nominally known based on the SMART data collection strategy, e.g., the rotation Rₚ₍ₖ₎^{p(k-1)} can be assumed to be Rₓ(0°)R_{y}(0°)R_{z}(−30°), such rotation might not lead to point clouds with reasonable alignment. FIG. 11 shows an example of the combined point clouds from the two LiDAR units collected at two scans (k=3 and k=5) for a single station in the US-231 dataset while using the nominal rotation angles for coarse registration. As can be seen in this figure, there is a significant misalignment between reconstructed point clouds.

Establishing conjugate features for coarse registration of multiple scans can be a challenging task due to the featureless nature of stockpile surfaces, the sparsity of individual sensor/LiDAR scans, and insufficient overlap between successive scans. To overcome this challenge an image-aided LiDAR coarse registration strategy is used in embodiments of the present disclosure. The incremental camera rotation angles can first be derived using a set of conjugate points established between successive images. The pole/mount rotation angles can then be derived using the estimated camera rotations and system calibration parameters. Due to the very short baseline between images captured at a single station, conventional approaches for establishing the relative orientation using essential matrix and epipolar geometry (e.g., the Nister approach) are not applicable. Therefore, the incremental rotation between successive scans is estimated using a set of identified conjugate points in the respective images while assuming that the camera is rotating around its perspective center. Estimation of the incremental camera rotation using a set of conjugate points and introduction of the proposed approach for the identification of these conjugate points follows.

For an established conjugate point between images captured at scans k−1 and k from a given station, Equation (1) can be reformulated as Equations (3-a) and (3-b), which can be further simplified to the form in Equation (4). Assuming that the components of camera-to-mount (e.g., camera-to-pole) lever arm r_{c}^{p} are relatively small, {Rₚ₍ₖ₋₁₎¹−Rₚ₍ₖ₎¹} r_{c}^{p} can be expected to be close to 0. Given the pole-to-camera boresight matrix Rₚ^{c}, the incremental camera rotation R_{c(k)}^{c(k-1)} can be represented as Rₚ^{c}Rₚ₍ₖ₎^{p(k-1)} R_{c}^{p}. Therefore, Equation (4) can be reformulated to the form in Equation (5). Given a set of conjugate points, the incremental camera rotation matrix R_{c(k)}^{c(k-1)} can be determined through a least squares adjustment to minimize the sum of squared differences Σᵢ₌₁^{m}[rᵢ^{c(k-1)}−λ(i, c, k−1, k) R_{c(k)}^{c(k-1)}rᵢ^{c(k)}]², where m is the number of identified conjugate points in the stereo-pair in question. To eliminate the scale factor λ(i, c, k−1, k) from the minimization process, the vectors rᵢ^{c(k-1)} and rᵢ^{c(k)} can be reduced to their respective unit vectors, i.e., r̅ᵢ^{c(k)} and r̅ᵢ^{c(k)}. Thus, R_{c(k)}^{c(k-1)} can be determined by minimizing Σᵢ₌₁^{m}[r̅ᵢ^{c(k-1)}-R_{c(k)}^{c(k-1)}r̅ᵢ^{c(k)}]². Estimation of R_{c(k)}^{c(k-1)} can be realized through a closed-form solution using quaternions by identifying the eigenvector corresponding to the largest eigenvalue for a (4×4) matrix defined by the pure quaternion representations of r̅ᵢ^{c(k-1)} and r̅ᵢ^{c(k)}. Estimating the incremental camera rotation angles can require a minimum of 3 well-distributed, conjugate points in two successive images. Once the incremental camera rotation matrices are derived, the rotation between the camera at a given scan k and the camera at the first scan can be estimated through rotation matrix concatenation, i.e., R_{c(k)}^{c(1)}=R_{c(2)}^{c(1)}R₍₃₎⁽²⁾ . . . R_{c(k)}^{c(k-1)}. Finally, the pole/mount rotation between scan k and the first scan can be derived; i.e., Rₚ₍ₖ₎^{p(1)} can be defined as R_{c}^{p}R_{c(k)}^{c(1)}Rₚ^{c}. The coarse registration of different pole/mount scans at a given location can then reduce to the identification of a set of conjugate points between successive images.

r_{I}^{m}(k−1)=Rₚ₍ₖ₋₁₎^{p(1)}r_{c}^{p}+λ(i, c, k−1)Rₚ₍ₖ₋₁₎⁽¹⁾R_{c}^{p}rᵢ^{c(k-1)} Equation (3-a)

r_{I}^{m}(k)=Rₚ₍ₖ₎^{p(1)}r_{c}^{p}+λ(i, c, k)Rₚ₍ₖ₎^{p(1)}R_{c}^{p}rᵢ^{c(k)} Equation (3-b)

{Rₚ₍ₖ₋₁₎⁽¹⁾−Rₚ₍ₖ₎^{p(1)}}r_{c}^{p}+λ(i, c, k−1)Rₚ₍ₖ₋₁₎^{p(1)}R_{c}^{p}rᵢ^{c(k-1)}=λ(i, c, k)Rₚ₍ₖ₎^{p(1)}R_{c}^{p}rᵢ^{c(k)} Equation (4)

rᵢ^{c(k-1)}=λ(i, c, k=1, k) R_{c(k)}^{c(k-1)}rᵢ^{c(k)} Equation (5)

Due to the featureless nature of the stockpile surface as well as the presence of repetitive patterns inside a storage facility (e.g., beam junctions, bolts, window corners, etc.) as well as the inability to use epipolar constraints for images with short baseline, traditional matching techniques would produce a large percentage of outliers. Therefore, embodiments of the present disclosure include a rotation-constrained image matching strategy where the nominal pole/mount rotation can be used to predict the location of a conjugate point in an image for a selected point in another one. In this regard, at least one embodiment can use Equation (5) to predict the location of a point in image k−1 for a selected feature in image k. To simplify the prediction process, the unknown scale factor λ(i, c, k−1, k) can be eliminated by dividing the first and second rows by the third one, resulting in Equation (6), where xᵢ′ and yᵢ′ are the image coordinates of conjugate points after correcting for the principal point offsets and lens distortions. The proposed image matching strategy (which may be referred to as “rotation-constrained matching”) will now be discussed.

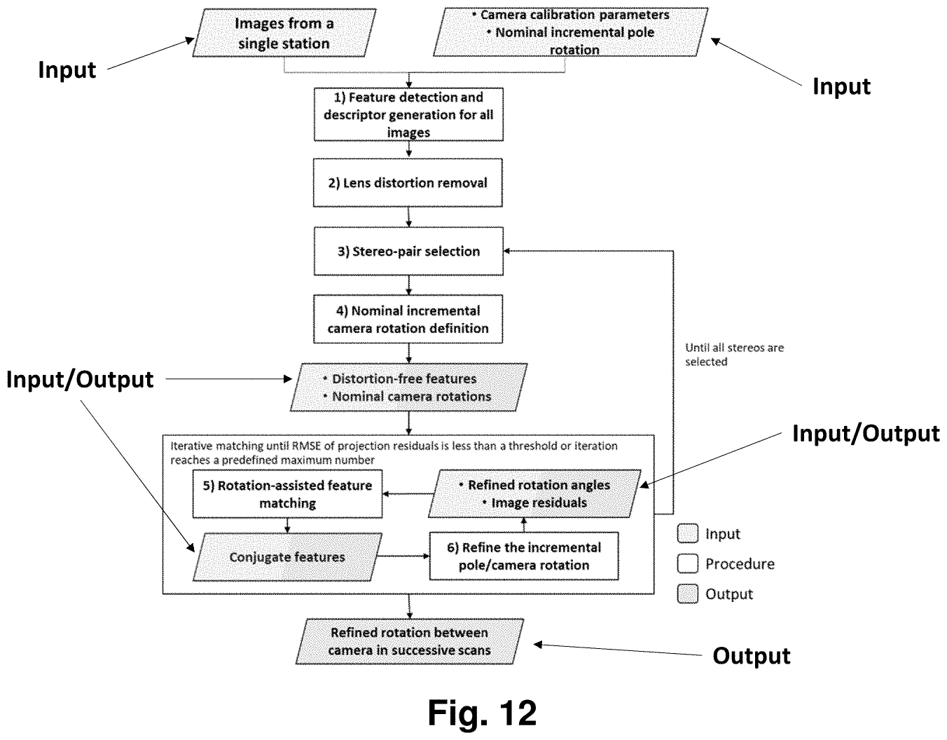

In various embodiments, nominal rotation angles between images are used in an iterative procedure to reduce the matching search space and thus mitigate matching ambiguity. FIG. 12 shows the workflow of the proposed rotation-constrained image matching approach. In the first step, a scale invariant feature transform (SIFT) detector and descriptor algorithm may be applied on all images captured at a single station. Lens distortions may then be removed from the coordinates of detected features. Next, two successive images may be selected for conducting image matching. In a fourth step, the incremental rotation matrix of the camera for the selected successive scans may be initially defined using the nominal pole/mount rotation angles while considering the camera mounting parameters. Given the nominal rotation matrix and extracted features, in the next step, an iterative procedure (steps 5 and 6) may be adopted to establish conjugate features and consequently, refine the incremental camera rotation angles between the two images.

$${x}_{i}^{′ c ( k - 1 )} = - c \frac{{r}_{11} {x}_{i}^{′ c ( k )} + {r}_{12} {y}_{i}^{′ c ( k )} - {r}_{13} c}{{r}_{31} {x}_{i}^{′ c ( k )} + {r}_{32} {y}_{i}^{′ c ( k )} - {r}_{23} c} \qquad Equation ( 6 ‐ a )$$

$${y}_{i}^{′ c ( k - 1 )} = - c \frac{{r}_{21} {x}_{i}^{′ c ( k )} + {r}_{22} {y}_{i}^{′ c ( k )} - {r}_{23} c}{{r}_{31} {x}_{i}^{′ c ( k )} + {r}_{32} {y}_{i}^{′ c ( k )} - {r}_{23} c} \qquad Equation ( 6 ‐ b )$$

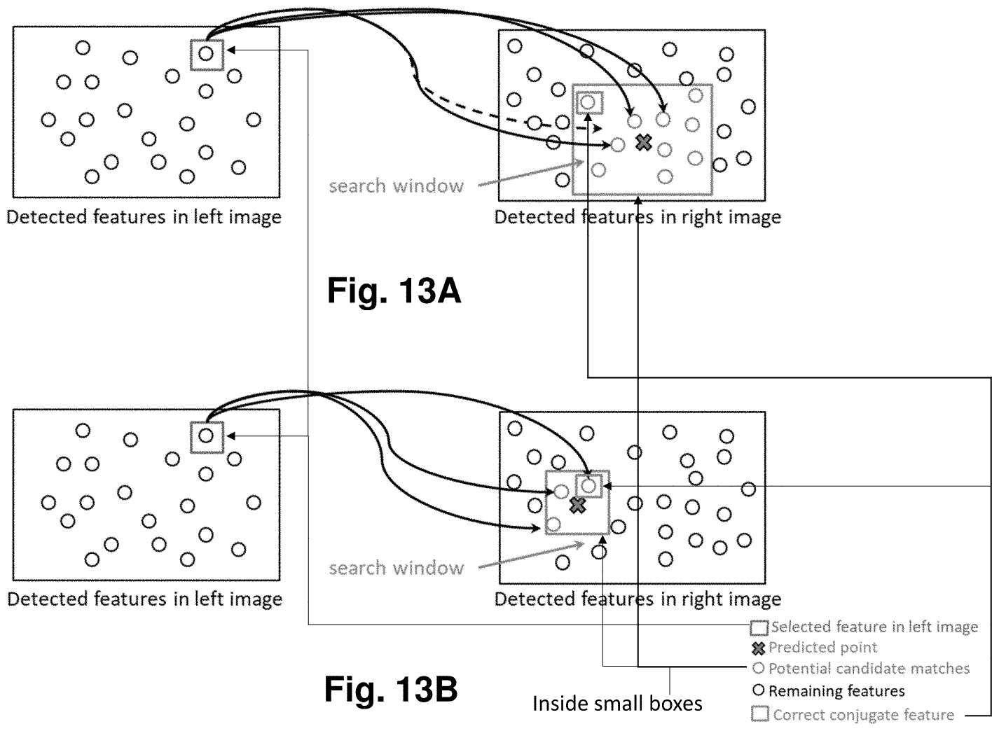

In an iterative procedure, each extracted feature in the left image may be projected to the right image using the current estimate of incremental camera rotation angles—Equations (6-a) and (6-b). The predicted point in the right image may then be used to establish a search window with a pre-defined dimension. This process is shown in FIG. 13A. The search window size may then be determined according to the reliability of the current estimate of pole/mount rotation angles as well as camera system calibration parameters. Among all SIFT features in the right image, only those located inside the search window may be considered as potential conjugate features. This strategy can eliminate some of the matching ambiguities caused by repetitive patterns in the imagery. Once a feature in the right image is selected as a matching hypothesis, a left-to-right and right-to-left consistency check may be conducted to remove more matching outliers. In a sixth step, conjugate features may be used to refine the incremental camera rotation between the two successive scans using the abovementioned quaternion-based least squares adjustment. At this stage, established conjugate points in the left image may be projected to the right one using the refined rotation angles, and the root-mean-square error (RMSE) value of coordinate differences between the projected points and their corresponding features in the right image may be estimated. The RMSE value may be referred to as projection residual. Steps 5 and 6 may be repeated until the projection residual is smaller than a threshold (e.g., 40 pixels) or a maximum number of iterations (e.g., 5) is reached.

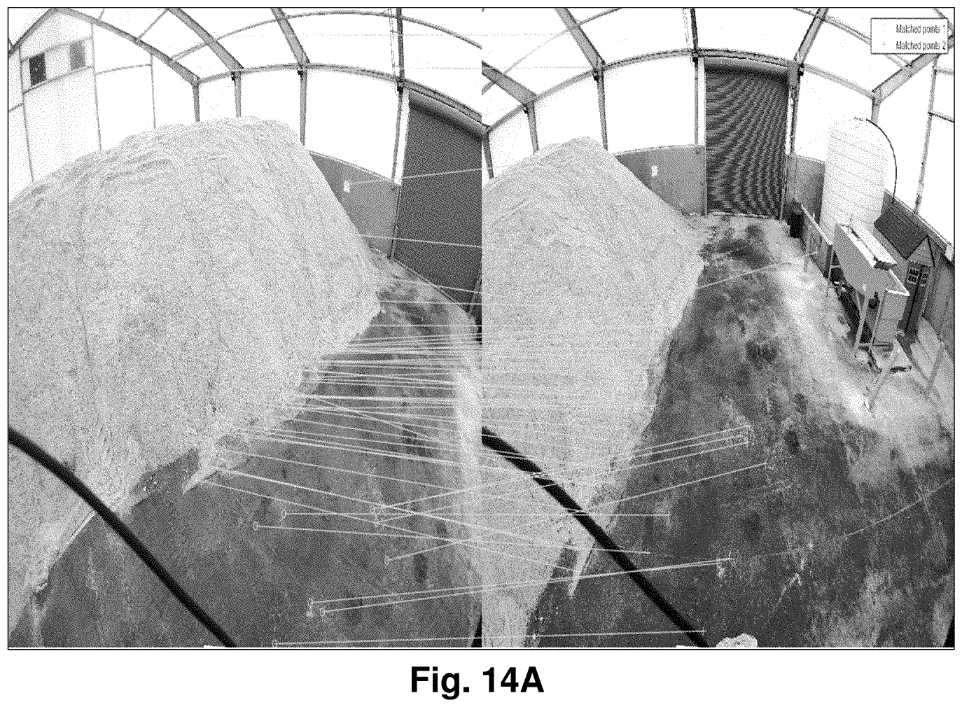

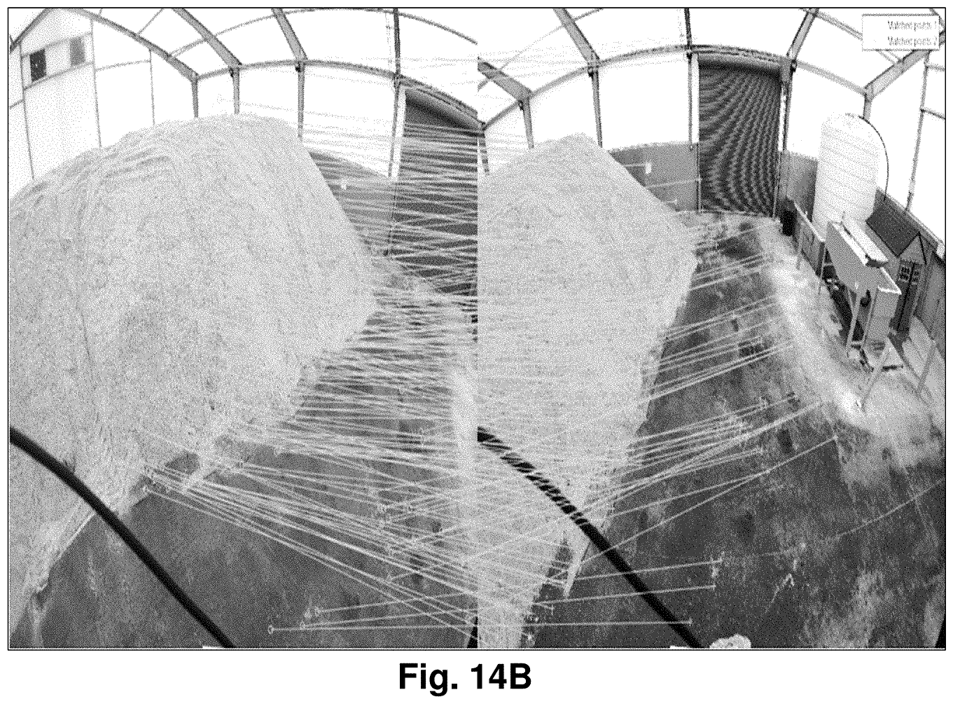

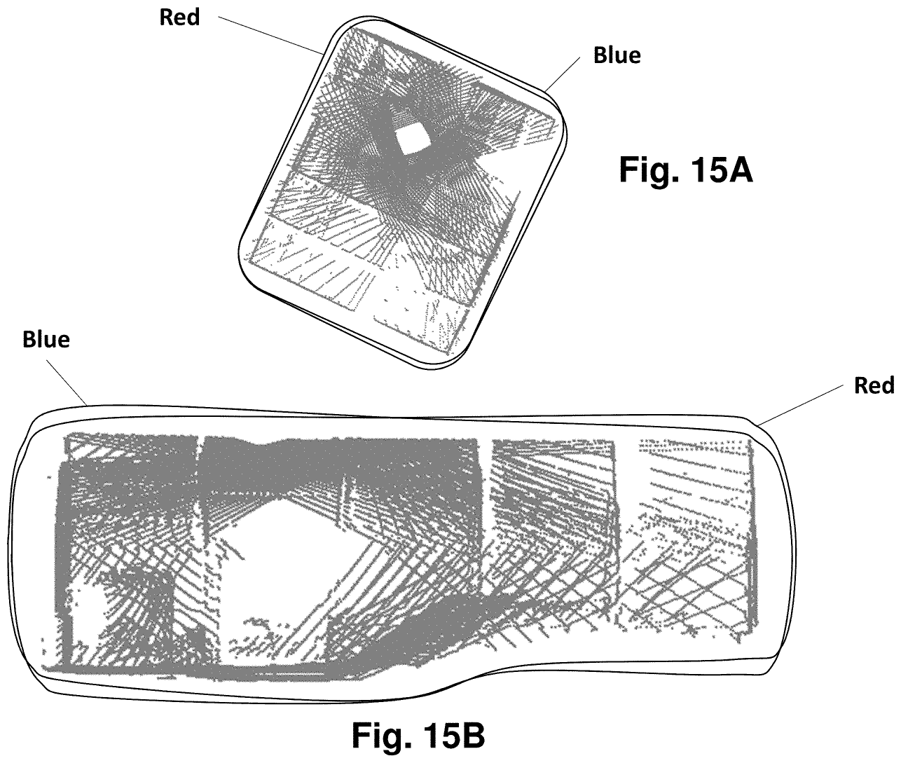

With the progression of iterations, more reliable conjugate features are established and, therefore, the estimated incremental rotation angles between successive images become more accurate. Consequently, the search window size is reduced by a constant factor (e.g., 0.8) after each iteration to further reduce matching ambiguity. This process is shown schematically in FIG. 13B. FIG. 14 shows sample matching results from the rotation-constrained matching strategy after one iteration (FIG. 14A) and two iterations (FIG. 14B) for the stereo-pair illustrated in FIG. 13. Comparing FIGS. 13 and 14, one can observe an improvement in the quality of matches; i.e., decrease in the percentage of outliers, when using the rotation-constrained matching. Also, through closer inspection of FIGS. 14A and 14B, one can see an increase in the number of matches, improvement in distribution of conjugate points, and decrease in the projection residual in the iterative approach compared to the case when relying on nominal rotation angles only, i.e., rotation-constrained matching with one iteration. To illustrate the feasibility of the proposed matching strategy, FIG. 15 shows the post-coarse registration alignment for the scans in FIG. 11, which had been originally aligned using the nominal pole/mount incremental rotation.

Feature Matching and Fine Registration of Point Clouds from a Single Station: Once the sensor/LiDAR scans are coarsely aligned, conjugate planar features in these scans can be identified through the similarity of surface orientation and spatial proximity. In other words, segmented planar patches from different scans can be first investigated to identify planar feature pairs that are almost coplanar. A planar feature pair is deemed coplanar if the angle between their surface normals do not exceed a threshold, and the plane-fitting root-mean-square error (RMSE) of the merged planes RMSE_{T} is not significantly larger than the plane-fitting RMSE for the individual planes RMSEₚ₁, RMSEₚ₂; RMSE_{T}=n_{RMSE}=max(RMSEₚ₁,RMSEₚ₂), where n_{RMSE} is a user-define multiplication factor. Once the coplanarity of a planar feature pair is confirmed, the spatial proximity of its constituents can be checked in order to reject matches between two far planes. An accepted match is considered as a new plane and the process can be repeated until no additional planes can be matched.

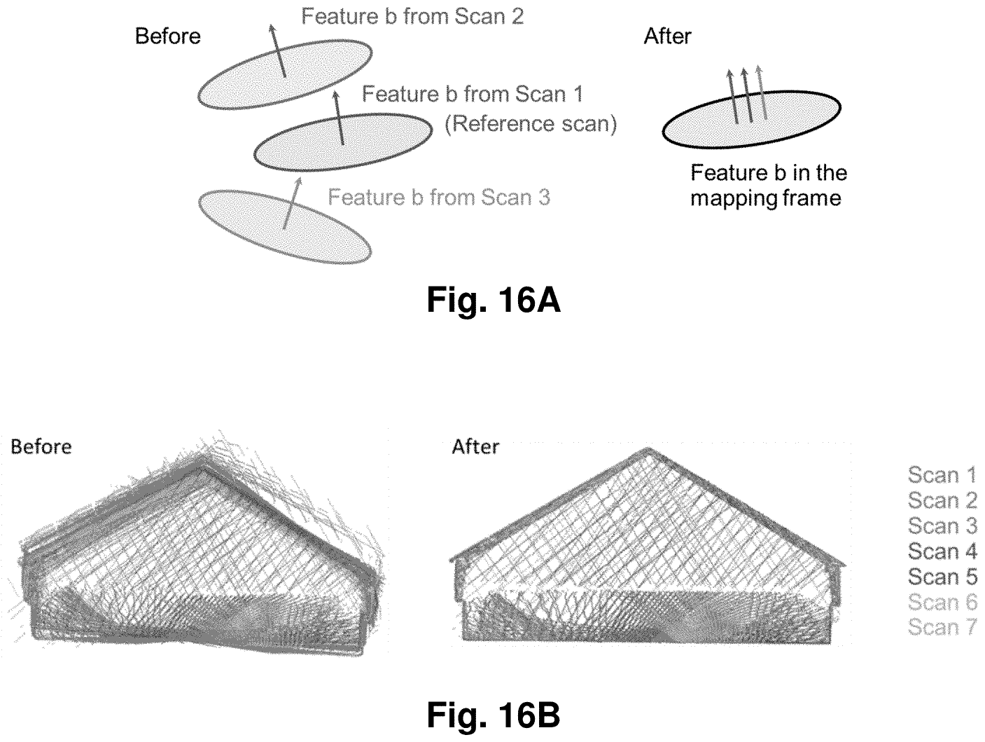

Following the identification of conjugate planes, a feature-based fine registration can be implemented. A key characteristic of the adopted fine registration strategy can be simultaneous alignment of multiple scans using features that have been automatically identified in the point clouds. Moreover, the post-alignment parametric model of the registration primitives can also be estimated. In one example embodiment, planar features extracted from the floor, walls, and/or ceiling of the facility are used as registration primitives. The conceptual basis of the fine registration is that conjugate features can fit a single parametric model after registration. The unknowns of the fine registration can include the transformation parameters for all the scans except one (i.e., one of the scans can be used to define the datum for the final point cloud) as well as the parameters of the best fitting planes. In terms of the parametric model, a 3D plane can be defined by the normal vector to the plane and signed normal distance from the origin to the plane. The fine registration parameters can be estimated through a least-squares adjustment by minimizing the squared sum of normal distances between the individual points along conjugate planar features and best fitting plane through these points following the point cloud alignment. A transformed point in the mapping frame, r_{I}^{m}, can be expressed symbolically by Equation (7), where r_{I}^{k} is an object point I in scan k; tₖ^{m} denotes the transformation parameters from scan k to the mapping frame as defined by the reference scan. The minimization function can be expressed mathematically by Equation (8), where f_{b}^{m} denotes the feature parameters for the b^{th} feature and nd(r_{I}^{m}, f_{b}^{m}) denotes the post-registration normal distance of the object point from its corresponding feature. FIGS. 16A and 16B presents sample point clouds before and after feature-based fine registration where the improvement in alignment can be clearly seen. The root mean square of the normal distances between the aligned point cloud for all the features and their respective fitted planes is adopted as a quality control metric. For truly planar features, the RMSE should be a fraction of the ranging noise for the used LiDAR units. To consider situations where the used primitives are not perfectly planar, the RMSE is expected to be 2 to 3 times the range noise.

$${r}_{I}^{m} = f ( {t}_{k}^{m} , {r}_{I}^{k} ) \qquad Equation ( 7 )$$

$${arg min}_{{t}_{k}^{m} , {f}_{b}^{m}} {\sum }_{∀ scans and features} {nd}^{2} ( {r}_{I}^{m} , {f}_{b}^{m} ) \qquad Equation ( 8 )$$

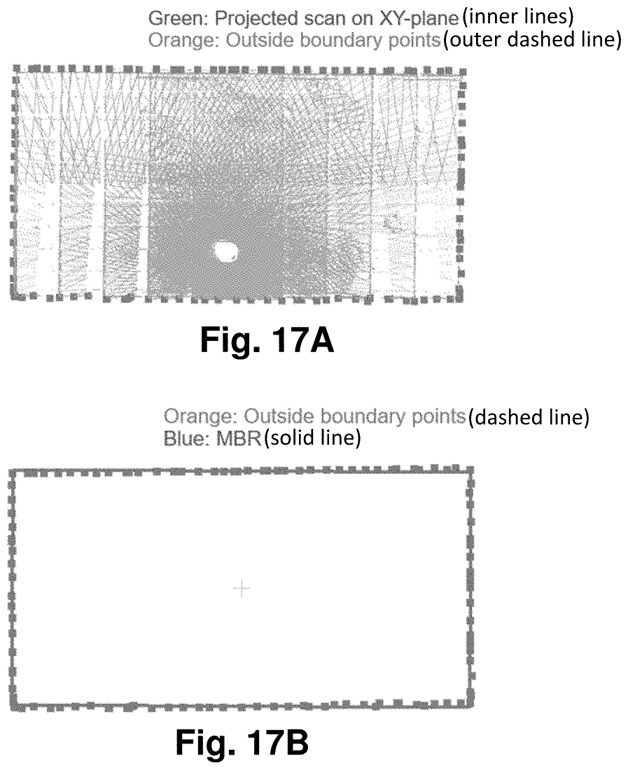

Coarse Registration of Point Clouds from Multiple Stations: At this stage, point clouds from the same station are well aligned. The goal of this step is to coarsely align point clouds from different stations, if available. Assuming in this example that the planimetric boundary of the involved facility (e.g., stockpile covering structure) can be represented by a rectangle, the multi-station coarse registration can be conducted by aligning these rectangles. In other embodiments different geometric shapes may be used, e.g., circles, octagons, etc. The process can start with levelling and shifting the registered point clouds from each station until the ground of facility aligns with the XY-plane. Then, the point clouds can be projected onto the XY-plane and the outside boundaries can be traced (see, e.g., FIG. 17A). Next, the minimum bounding rectangles (MBR) of the boundary for each station can be derived. Each MBR is represented by four points in FIG. 17B. Finally, the inter-station coarse registration can be realized by aligning the four points representing the MBRs from the different stations. In the SMART operation, the pole/mount orientation in the first scan at each station can be set-up to have a similar orientation relative to the facility. Since, the pole/mount coordinate system at the first scan for different stations can be used as a reference, the coarse registration rotation angles in the XY-plane should be small (i.e., there will be little or no ambiguity in the rotation estimation for multi-station coarse registration when dealing with rectangular facilities). Following the multi-station coarse registration, a feature matching and fine registration step similar to what has been explained in the Feature Matching and Fine Registration of Point Clouds from a Single Station section for a single station can be repeated while considering all the scans at all the stations.

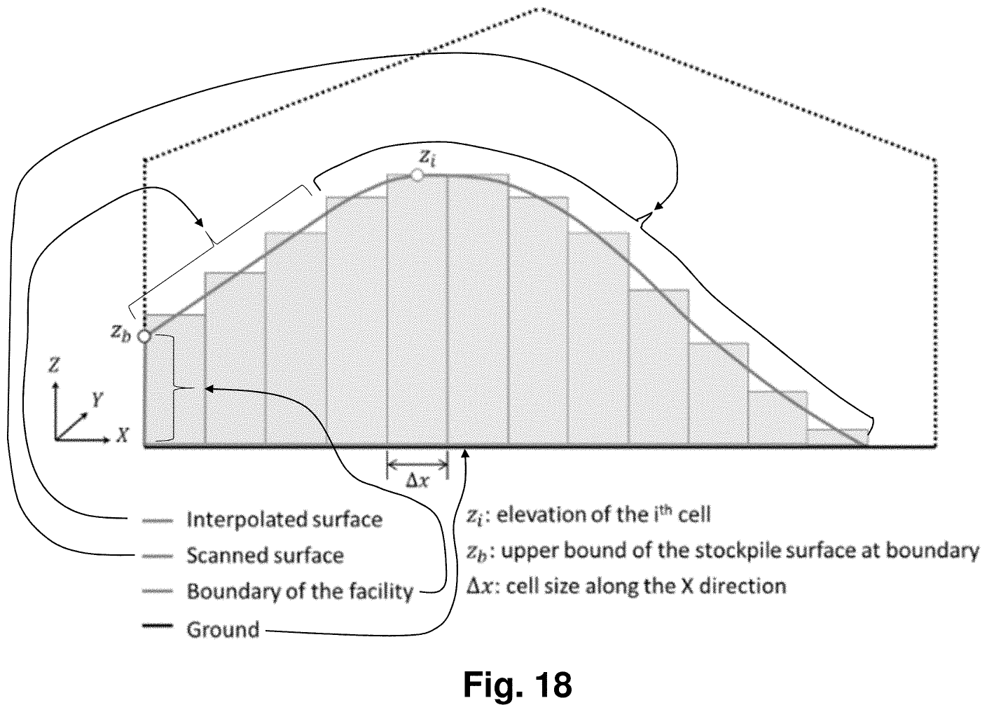

Volume Estimation: For volume estimation, a digital surface model (DSM) can be generated using the levelled point cloud for the scanned stockpile surface and boundaries of the facility. The cell size can be chosen based on a rough estimate of the average point spacing. Regardless of the system setup, occlusions should be expected. Therefore, the stockpile surface in occluded areas can be derived using bilinear interpolation between the scanned surface and facility boundaries. Finally, the volume (V) can be defined according to Equation (9), where n_{ceii} is the number of DSM cells, zᵢ is the elevation at the i^{th} DSM cell, z_{ground} is the elevation of ground, and Δx and Δy are the cell size along the X and Y directions, respectively. FIG. 18 shows a 2D schematic diagram that illustrates the 3D volume estimation process. The space bounded by the scanned surface, ground, boundary of the facility, and interpolated5 surface is the estimated stockpile volume.

V=Σᵢ₌₁ⁿ^{_{cell}}(zᵢ−z_{ground})ΔxΔy Equation (9)

In some embodiments, after data collection coarse and fine registrations of the point clouds can be used to determine the volume of the stockpile. As visualized using the images in FIGS. 11A/11B and 15A/15B, the registration of sensor scans (e.g., LiDAR sensor scans) is initially coarse as shown in FIGS. 11A and 14B. The outlines, which are labeled as “blue” and “red” to reflect the colors in the color versions of the figures, are added around the point clouds in FIGS. 11A and 11B to better assist the reader with interpreting the coarse registration between different positions and/or orientations of the system in relation to the stockpile when the drawings are rendered in black/white/grayscale. Successive images are utilized to obtain scan-to-scan transformation through constrained iterative matching of Scale Invariant Feature Transform (SIFT) features in, for example, two successive images at a time. The iterative matching can avoid incorrect matches that can occur with a stockpile surface that is relatively homogeneous. Once the scans are coarsely registered, the individual scans may be segmented to extract planar features (e.g., features of structures in the vicinity of the stockpile), which are matched across the different scans. A final optimization routine, which may be based on least squares adjustments, can be initiated to present a feature-based fine registration of the scans with the system in two different locations and/or orientations as shown in FIGS. 15A and 15B. The outlines labeled as blue and red are much more closely aligned in the point clouds depicted in FIGS. 15A and 15B than they are in FIGS. 11A and 11B.

If more than one station was collected at a facility, then the fine registered scans from each location can be used to perform a coarse registration of all stations using a boundary tracing and identified minimum bounding shape (e.g., a rectangle bounding shape) methods for the registered scans at the individual stations. The multi-station coarse registration may then be followed by a fine registration using matched planar features in the combined multi-station scans.

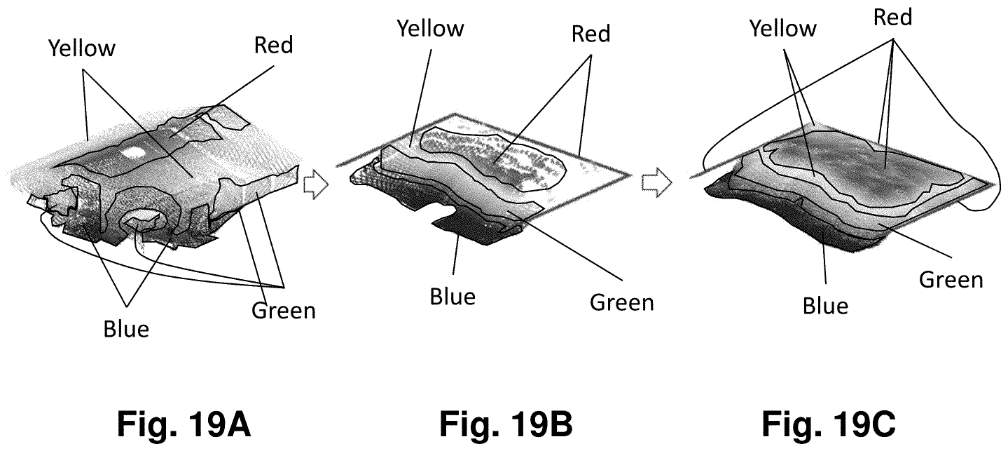

To compute stockpile volume, the multi-station fine registered point clouds can be levelled until the ground of the facility aligns with the XY plane. Then, a digital surface model (DSM) can be generated by defining grid cells of identical size (e.g., 0.1 m×0.1 m) uniformly in the XY plane over the stockpile area within the boundary of the facility, as shown in FIGS. 19A, 19B and 19C. Each cell may be assigned a height at the center of the cell based on a bilinear interpolation of the sensor (e.g., LiDAR) surface of the stockpile, which can also establish the stockpile surface in occluded areas.

It is worth noting that when generating the digital surface model (DSM) for a given facility, the number of grid cells can depend on the cell size. The cell size can, in turn, affect data processing time, e.g., the smaller the cell, the more expensive it will be in terms of computation needed to generate the DSM. The selection of the cell size (e.g., 0.1 m×0.1 m) in some embodiments of the present disclosure did not result in a significant processing overhead. For example, on a computer with an 8 core Intel i₅® processor and 8 GB RAM, the DSM generation typically took about 30 seconds or less.

Embodiments of the present disclosure, which may be referred to generally as Stockpile Monitoring and Reporting Technology (SMART) systems, provide accurate volume estimations of indoor stockpiles, such as indoor stockpiles of salt. In some embodiments, after system calibration the stockpile volume may be estimated through six steps: segmentation of planar features from individual scans, image-based coarse registration of sensor/LiDAR scans at a single station, feature matching and fine registration of sensor/LiDAR point clouds from a single station, coarse registration of point clouds from different stations, feature matching and fine registration of sensor/LiDAR point clouds from different stations, and DSM generation for volume estimation.

In some embodiments, such as those where a stockpile measuring system according to embodiment of this disclosure will be mounted to a stockpile covering structure, a preliminary test can be conducted to determine the optimal location for the SMART system. The test can be conducting by temporarily mounting of the system on a pole or mobile boom lift. Scans at two or more mounting locations can be performed to determine the optimal location, with the optimal location being chosen where the system detects as much of the back side of the stockpile while still capturing the front of the stockpile where most of the material (e.g., salt) will be removed. Mounting the system higher above the stockpile, such as near the peak of a covering structure, enhancing the ability of the system to directly detect the entire stockpile.

Some embodiments are rotated by hand, while other embodiments may be rotated using a motor. Rotation with motors can provide greater and more accurate coverage of the storage facility without overlap, improved coarse registration quality, and reduced estimation errors.

Embodiments address the limitations of current stockpile volume estimation techniques by providing time-efficient, cost-effective, and scalable solutions for routine monitoring of stockpiles with varying size and shape complexities. This can be done through a careful system design integrating, for example, an RGB camera, two LiDAR units, and an extendable mount/tripod.

In additional embodiments an image-aided coarse registration technique can be used to mitigate challenges in identifying common features in sparse sensor/LiDAR scans with insufficient overlap. Embodiments utilize designed system characteristics and operation to derive reliable sets of conjugate points in successive images for precise estimation of the incremental pole/mount rotation at a given station.

A scan-line-based segmentation (SLS) approach for extracting planar features from spinning multi-beam LiDAR scans may be used in some embodiments. The SLS can handle significant variability in point density and can provide a set of planar features that could be used for reliable fine registration.

While embodiments discussed herein focus on estimating volumes of salt stockpiles, these embodiments are equally applicable for estimate/measuring the volumes of other types of stockpiles, such as aggregate, rocks, grain, and landscaping mulch. Moreover, for outdoor environments, the RTK-GNSS module can be used to provide prior information for coarse and fine registration of point clouds from multiple stations.

Accuracy testing has demonstrated that embodiments of the present disclosure estimate stockpile volumes within approximately 0.1% of the actual volume as measured with independent methods and by repositioning (e.g., reshaping) a stockpile of material with known volume. Moreover, results can be obtained within minutes, assisting personnel with managing the stockpiles.

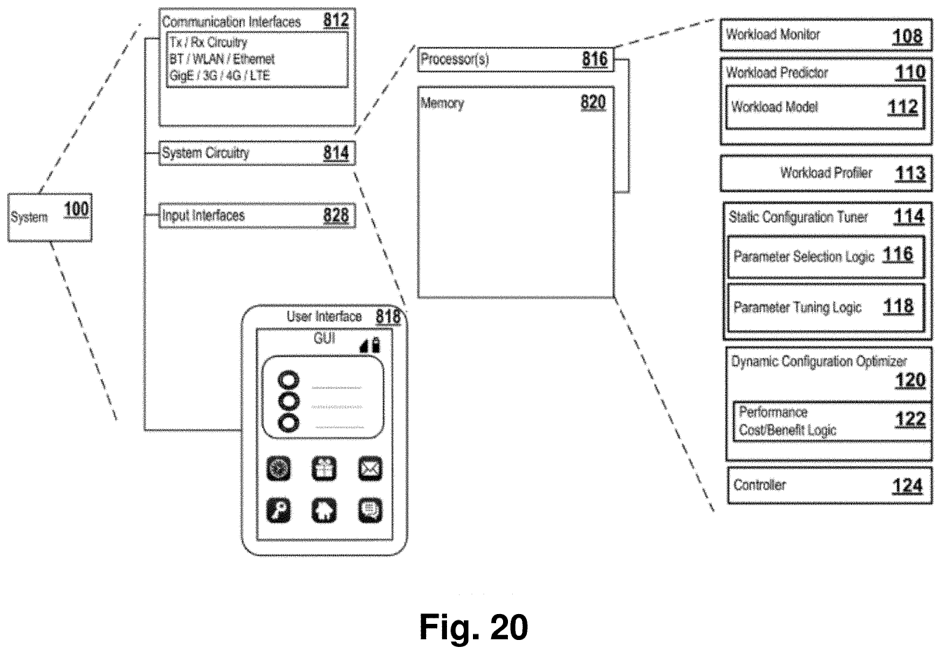

FIG. 20 illustrates a SMART system 100 according to one embodiment of the present disclosure. The system 100 may include communication interfaces 812, input interfaces 828 and/or system circuitry 814. The system circuitry 814 may include a processor 816 or multiple processors. Alternatively or in addition, the system circuitry 814 may include memory 820.

The processor 816 may be in communication with the memory 820. In some examples, the processor 816 may also be in communication with additional elements, such as the communication interfaces 812, the input interfaces 828, and/or the user interface 818. Examples of the processor 816 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 816 may be one or more devices operable to execute logic. The logic may include computer executable instructions or computer code stored in the memory 820 or in other memory that when executed by the processor 816, cause the processor 816 to perform the operations the workload monitor 108, the workload predictor 110, the workload model 112, the workload profiler 113, the static configuration tuner 114, the perimeter selection logic 116, the parameter tuning logic 118, the dynamic configuration optimizer 120, the performance cost/benefit logic 122, and/or the system 100. The computer code may include instructions executable with the processor 816.

The memory 820 may be any device for storing and retrieving data or any combination thereof. The memory 820 may include non-volatile and/or volatile memory, such as a random access memory (RAM), a read-only memory (ROM), an erasable programmable read-only memory (EPROM), or flash memory. Alternatively or in addition, the memory 820 may include an optical, magnetic (hard-drive), solid-state drive or any other form of data storage device. The memory 820 may include at least one of the workload monitor 108, the workload predictor 110, the workload model 112, the workload profiler 113, the static configuration tuner 114, the perimeter selection logic 116, the parameter tuning logic 118, the dynamic configuration optimizer 120, the performance cost/benefit logic 122, and/or the system 100. Alternatively or in addition, the memory may include any other component or subcomponent of the system 100 described herein.

The user interface 818 may include any interface for displaying graphical information. The system circuitry 814 and/or the communications interface(s) 812 may communicate signals or commands to the user interface 818 that cause the user interface to display graphical information. Alternatively or in addition, the user interface 818 may be remote to the system 100 and the system circuitry 814 and/or communication interface(s) may communicate instructions, such as HTML, to the user interface to cause the user interface to display, compile, and/or render information content. In some examples, the content displayed by the user interface 818 may be interactive or responsive to user input. For example, the user interface 818 may communicate signals, messages, and/or information back to the communications interface 812 or system circuitry 814.

The system 100 may be implemented in many ways. In some examples, the system 100 may be implemented with one or more logical components. For example, the logical components of the system 100 may be hardware or a combination of hardware and software. The logical components may include the workload monitor 108, the workload predictor 110, the workload model 112, the workload profiler 113, the static configuration tuner 114, the perimeter selection logic 116, the parameter tuning logic 118, the dynamic configuration optimizer 120, the performance cost/benefit logic 122, the system 100 and/or any component or subcomponent of the system 100. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively or in addition, each component may include memory hardware, such as a portion of the memory 820, for example, that comprises instructions executable with the processor 816 or other processor to implement one or more of the features of the logical components. When any one of the logical components includes the portion of the memory that comprises instructions executable with the processor 816, the component may or may not include the processor 816. In some examples, each logical component may just be the portion of the memory 820 or other physical memory that comprises instructions executable with the processor 816, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium may include a hard disk, a floppy disk, a CD-ROM, a flash drive, a cache, volatile memory, non-volatile memory, RAM, flash memory, or any other type of computer readable storage medium or storage media. The computer readable storage medium may include any type of non-transitory computer readable medium, such as a CD-ROM, a volatile memory, a non-volatile memory, ROM, RAM, or any other suitable storage device.

The processing capability of the system may be distributed among multiple entities, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks, flash memory drives, floppy disks, and CD-ROMs. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transfer through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory. Programs may be parts of a single program, separate programs, or distributed across several memories and processors.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

Embodiments of the present disclosure are able to determine stockpile volumes irrespective of colorations of the material in the stockpiles. For example, removal and refill of salt for melting ice on roadways over time-from untampered “white” appearing salt in the early days of a season to colored salt (which may be due to the addition of chemicals or the fading of the top layer over time) as the season progresses has little effect (if any) of the accuracy of the systems and methods disclosed herein.

Reference systems that may be used herein can refer generally to various directions (e.g., upper, lower, forward and rearward), which are merely offered to assist the reader in understanding the various embodiments of the disclosure and are not to be interpreted as limiting. Other reference systems may be used to describe various embodiments, such as referring to the direction of projectile movement as it exits the firearm as being up, down, rearward or any other direction.

To clarify the use of and to hereby provide notice to the public, the phrases “at least one of A, B, . . . and N” or “at least one of A, B, N, or combinations thereof” or “A, B, . . . and/or N” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. As one example, “A, B and/or C” indicates that all of the following are contemplated: “A alone,” “B alone,” “C alone,” “A and B together,” “A and C together,” “B and C together,” and “A, B and C together.” If the order of the items matters, then the term “and/or” combines items that can be taken separately or together in any order. For example, “A, B and/or C” indicates that all of the following are contemplated: “A alone,” “B alone,” “C alone,” “A and B together,” “B and A together,” “A and C together,” “C and A together,” “B and C together,” “C and B together,” “A, B and C together,” “A, C and B together,” “B, A and C together,” “B, C and A together,” “C, A and B together,” and “C, B and A together.”

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

1. A system for determining the volume of a stockpile, comprising:
a sensor package including
an image sensor configured to collect image data of a stockpile, and
a light detection and ranging sensor connected to the image sensor and configured to collect additional information of the stockpile; and
one or more processors configured to receive the image data,
generate a first estimate of the location and rotational orientation of the image sensor in relation to the stockpile based on the image data from the image sensor,
receive the additional information from the light detection and ranging sensor,
generate a second estimate of the location and rotational orientation of the image sensor in relation to the stockpile based on the image data,
generate an estimate of the stockpile volume based on the second estimate of the location and rotational orientation of the image sensor, and
provide the estimate of the stockpile volume to a user interface.

2. The system of claim 1, wherein the one or more processors are configured to generate a first estimate of the location and rotational orientation of the image sensor utilizing quaternions.

3. The system of claim 2, wherein the one or more processors are configured to generate a first estimate of the location and rotational orientation of the image sensor utilizing image comparison.

4. The system of claim 1, wherein the one or more processors are configured to generate a first estimate of the location and rotational orientation of the image sensor by comparison of images at different rotational orientations and different locations in relation to the stockpile.

5. The system of claim 1, wherein the one or more processors are configured to perform segmentation of planar features from individual scans.

6. The system of claim 1, wherein the one or more processors are configured to perform image-based coarse registration of sensor scans at a single data collection location.

7. The system of claim 1, wherein the one or more processors are configured to perform feature matching and fine registration of sensor point clouds from a single data collection location.

8. The system of claim 1, the one or more processors are configured to perform coarse registration of point clouds from different data collection locations.

9. The system of claim 1, wherein the one or more processors are configured to perform feature matching and fine registration of sensor point clouds from different data collection locations.

10. The system of claim 1, wherein the one or more processors are configured to perform digital surface model generation for volume estimation.

11. The system of claim 1, further comprising:
an extension pole connected to the sensor package, wherein the extension pole is hand extendable and hand rotatable to raise and rotate the sensor package above the stockpile.

12. A method for determining the volume of a stockpile, comprising:
receiving image data related to the stockpile from an image sensor;
receiving range information data from a range sensor to multiple portions of the surface of the stockpile;
generating with a processor a first estimate of the location of the image sensor in relation to the stockpile based on the image data and the range information data;
generating with a processor a second estimate of the locations and rotational orientations of the image sensor in relation to the stockpile based on the image data;
generating with a processor an estimate of the stockpile volume based on the second estimate of the location and rotational orientation of the image sensor; and
providing via a user interface information concerning the volume of the stockpile.

13. The method of claim 12, wherein said generating with a processor the first estimate of the location of the image sensor in relation to the stockpile includes utilizing quaternions and image comparison.

14. The system of claim 12, wherein said generating with a processor a second estimate of the locations and rotational orientations of the image sensor in relation to the stockpile includes comparison of images at different rotational orientations and different locations in relation to the stockpile.

15. The system of claim 12, wherein said generating with a processor an estimate of the stockpile volume includes performing segmentation of planar features from individual scans.

16. The system of claim 12, wherein said generating with a processor an estimate of the stockpile volume includes
performing image-based coarse registration of sensor scans at a single data collection location, and
performing feature matching and fine registration of sensor point clouds from a single data collection location.

17. The system of claim 12, wherein said generating with a processor an estimate of the stockpile volume includes
performing coarse registration of point clouds from different data collection locations, and
performing feature matching and fine registration of sensor point clouds from different data collection locations.

18. The system of claim 12, wherein said generating with a processor an estimate of the stockpile volume includes performing digital surface model generation for volume estimation.

19. The method of claim 12, wherein:
said generating with a processor the first estimate of the location of the image sensor in relation to the stockpile includes utilizing quaternions and image comparison;
said generating with a processor a second estimate of the locations and rotational orientations of the image sensor in relation to the stockpile includes comparison of images at different rotational orientations and different locations in relation to the stockpile; and
said generating with a processor an estimate of the stockpile volume includes
performing segmentation of planar features from individual scans, performing image-based coarse registration of sensor scans at a data collection location, and performing feature matching and fine registration of sensor point clouds from a data collection location, and
performing coarse registration of point clouds from different data collection locations, and performing feature matching and fine registration of sensor point clouds from different data collection locations.

20. The system of claim 1, wherein the one or more processors are configured to:
generate a first estimate of the location and rotational orientation of the image sensor utilizing quaternions;
generate a first estimate of the location and rotational orientation of the image sensor utilizing image comparison;
generate a first estimate of the location and rotational orientation of the image sensor by comparison of images at different rotational orientations and different locations in relation to the stockpile;
perform segmentation of planar features from individual scans. perform image-based coarse registration of sensor scans at a single data collection location;
perform feature matching and fine registration of sensor point clouds from a first data collection location;
perform coarse registration of point clouds from different data collection locations;
perform feature matching and fine registration of sensor point clouds from a second data collection location; and
perform digital surface model generation for volume estimation.
